(19) United States
(12) Patent Application Publication
(10) Pub. No.: US 2008/0039120 A1
(43) Pub. Date: Feb. 14, 2008

(54) VISUAL INPUTS FOR NAVIGATION

(75) Inventor: Assaf GAD, Petah Tikva (IL)

Correspondence Address: OBLON, SPIVAK, MCCLELLAND MAIER & NEUSTADT, P.C., 1940 DUKE STREET, ALEXANDRIA, VA, 22314, US

(73) Assignee: TELMAP LTD., Herzlia (IL)

(21) Appl. No.: 11/621,270

(22) Filed: Jan. 9, 2007

Related U.S. Application Data
(60) Provisional application No. 60/776,579, filed on Feb. 24, 2006.

(51) Int. Cl. G01C 21/00

(52) U.S. Cl. 455/456.2; 455/456.1

(57) ABSTRACT

An interface is provided to a mobile navigation system in which an optical image of a point-of-interest acquired by cellular telephone devices is an input to the system. Textual and optionally other location information is extracted from the image, and used by the navigation system to identify coordinates and vectors relating to the point-of-interest. The results are stored and may be subsequently recalled to provide mapping and routing information to the cellular telephone device, whose position relative to the point-of-interest may have changed. Optical images may be uploaded from telephone device to the navigation system automatically or interactively, and can be processed remotely, generally without further user interaction.

### CROSS-REFERENCE TO RELATED APPLICATIONS

This application claims the benefit of U.S. Provisional Application 60/776,579, filed Feb. 23, 2006, which is herein incorporated by reference.

### BACKGROUND OF THE INVENTION

1. Field of the Invention

This invention relates to methods and mobile systems for providing navigation and location information. More particularly, this invention relates to input interfaces for navigation and location systems.

2. Description of the Related Art

TABLE 1
Acronyms and Abbreviations

| | |
|---|---|
| API | Application Programing Interface |
| ASCII | American Standard Code for Information |
| | Interchange |
| GPS | Global Positioning System |
| HTTP | Hypertext Transfer Protocol |
| MMS | Multimedia Messaging System |
| MSC | Mobile Switching Center |
| OCR | Optical Character Recognition |
| PDA | Personal Digital Assistant |
| POI | Point-of-interest |
| PSTN | Public Switched Telephone Network |
| SNMP | Simple Network Management Protocol |
| SOAP | Simple Object Access Protocol |
| TCP/IP | Transmission Control Protocol/Internet |
| | Protocol |

A variety of systems are known in the art for providing drivers with in-vehicle electronic routing maps and navigation aids. These systems are commonly coupled to a location-finding device in the vehicle, such as a global positioning system (GPS) receiver. The GPS receiver automatically determines the current location of the vehicle, to be displayed on the map and used in determining routing instructions. Today, mobile navigation systems enable users to find their destinations quickly and easily. Additionally, such systems allow location-based searches, typically by integrating traffic services and point-of-interest information databases.

In-vehicle navigation systems fall into two general categories: “on-board” systems, in which the map data are stored electronically in the vehicle (typically on optical or magnetic media); and “off-board” systems, in which the map data are furnished by a remote map server. These systems typically use a client program running on a smart cellular telephone or personal digital assistant (PDA) in the vehicle to retrieve information from the server over a wireless link, and to display maps and provide navigation instructions to the driver.

Various off-board navigation systems are described in the patent literature. For example, U.S. Pat. No. 6,381,535, whose disclosure is incorporated herein by reference, describes improvements required to convert a portable radiotelephone into a mobile terminal capable of functioning as a navigational aid system. Itinerary requests of the mobile terminal are transmitted to a centralized server by a radio relay link. The server calculates the itinerary requested, and transmits the itinerary to the mobile terminal in the form of data concerning straight lines and arc segments constituting the itinerary. The server also evaluates the possibility of the vehicle deviating from its course and transmits data concerning segments of possible deviation itineraries in an area of proximity to the main itinerary.

Commonly assigned U.S. Pat. No. 7,089,110, whose disclosure is herein incorporated by reference, discloses techniques for navigation in which map data are stored on a server. The map data can include vector information delineating roads in a map. A portion of the vector information corresponds to an area in which a user of a mobile client device is traveling is downloaded from the server to the client device. Approximate position coordinates of the user are found using a location providing device associated with the client device and are corrected in the client device, using the downloaded vector information, so as to determine a location of the user on one of the roads in the map. A navigation aid is provided to the user of the client device based on the determined location.

### SUMMARY OF THE INVENTION

Conventional inputs to navigation systems have been a limiting factor for mobile users. Mobile device keyboards are frustrating for unpracticed users. More advanced systems may additionally or alternatively allow vocal input, using known speech-to-text processing techniques. However, the vocal interface may require extensive training, or may be rendered inaccurate by background noise, which is common in vehicular and urban pedestrian environments. Vocal interfaces have been found to be suboptimum in practice.

The inventors have noted the continually improving photographic capabilities of now ubiquitous cellular telephone devices, and have determined that these features can be exploited to provide an optical interface with navigation systems in a way that is believed to be heretofore unrealized.

Regulatory authorities have permitted the proliferation in the United States of incompatible cellular telephone services. Thus, one seeking to develop improved uses for cellular telephone devices is confronted with a lack of a general platform that supports the cellular telephones of different service providers in different areas of the country, and must deal with co-existing incompatible communications protocols. Furthermore, many older digital cellular telephone devices remain in service. These may have some integral optical capabilities, or may accept input from an external optical device, but they have limited processing capabilities and memory capacity.

In some embodiments of the present invention, techniques for using such devices as an interface to a mobile navigation system recognize and deal with all the above-noted issues. According to aspects of the invention, these technical difficulties have been overcome, wherein an interface is provided in which optical images acquired by cellular telephone devices serve as inputs to a mobile navigation system. This is achieved transparently to the user. In some embodiments, no modification of the cellular telephone devices is necessary. In other embodiments, performance is enhanced by downloading and installing specialized programs in the cellular telephone devices that are adapted to the mobile navigation system. Optical images may be uploaded automatically or interactively, and can be processed remotely, generally without further user interaction.

An embodiment of the invention provides a method for navigation, which is carried out by capturing an image using a mobile device, transferring data relating to the image to a remote facility, processing the image to identify a location associated with the image, and communicating information from the remote facility to the mobile device describing navigation to the location.

According to one aspect of the method, processing the image includes wirelessly transmitting the image from the mobile device to a remote server.

According to another aspect of the method, processing the image includes performing optical character recognition. The image may be processed in the mobile device. Alternatively, the image may be processed in a remote server.

According to a further aspect of the method, processing the image includes referencing an image database.

According to yet another aspect of the method, the mobile device is a cellular telephone having a camera incorporated therein.

In one aspect of the method, capturing an image includes acquiring the image with one mobile device, and transmitting the image from the one mobile device to another mobile device.

Additional embodiments of the invention are realized as computer software products and mobile information devices.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a simplified pictorial illustration of a real-time navigation system that is constructed and operative in accordance with a disclosed embodiment of the invention;

FIG. 2 is a simplified functional block diagram of a map server in the navigation system shown in FIG. 1, in accordance with a disclosed embodiment of the invention;

FIG. 3 is a block diagram of a request processor in the map server of FIG. 2 in accordance with a disclosed embodiment of the invention;

FIG. 4 is a pictorial diagram of a wireless device that is constructed and operative for generating visual input for navigation in accordance with a disclosed embodiment of the invention;

FIG. 5 is a flow chart of a method of dynamic navigation in accordance with a disclosed embodiment of the invention; and

FIG. 6 is a flow chart of a method of dynamic navigation in accordance with an alternate embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client/server environment, such software programming code may be stored on a client or a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems.

### Embodiment 1

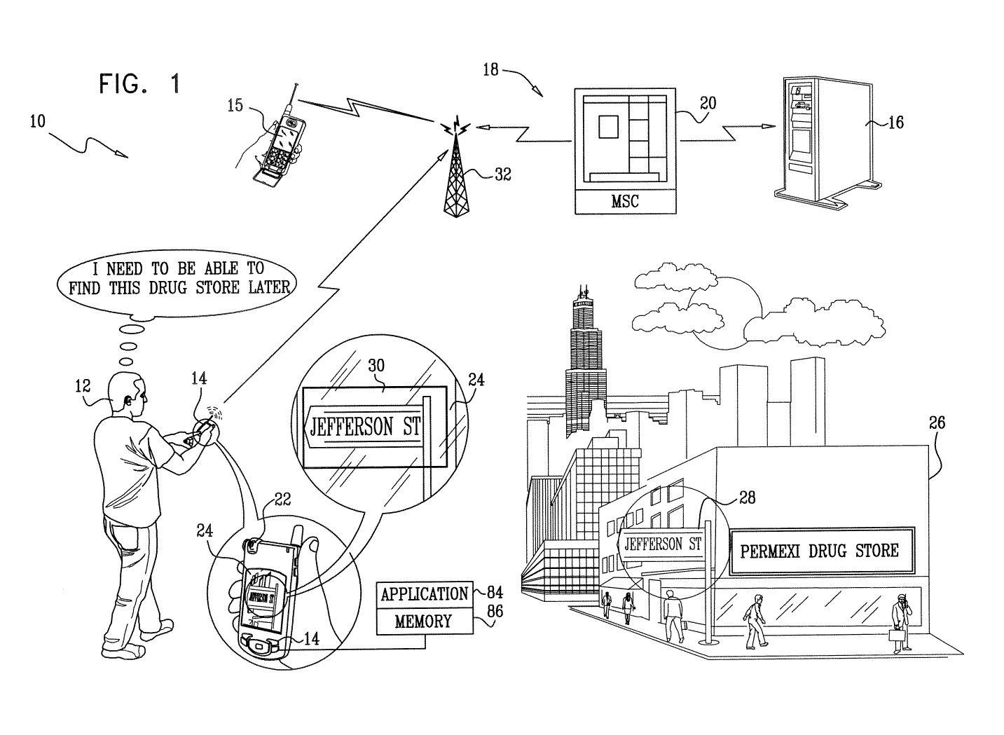

Turning now to the drawings, reference is initially made to FIG. 1, which is a simplified pictorial illustration of a real-time navigation system 10 constructed and operative in accordance with a disclosed embodiment of the invention. In this illustration, a pedestrian 12, using a wireless device 14, communicates with a map server 16 via a commercial wireless telephone network 18. The network 18 may include conventional traffic-handling elements, for example, a mobile switching center 20 (MSC), and is capable of processing data calls using known communications protocols. The mobile switching center 20 is linked to the map server 16 in any suitable way, for example via the public switched telephone network (PSTN), a private communications network, or via the Internet.

The wireless device 14 is typically a handheld cellular telephone, having an integral photographic camera 22. A suitable device for use as the wireless device 14 is the Nokia® model N73 cellular telephone, provided with a 3.2 megapixel camera with autofocus and integrated flash capabilities. This model is also provided with a screen display 24, and is capable of transmitting images via Internet email, Bluetooth connectivity, SOAP, or MMS. Many other cellular telephones that can be used as the wireless device 14 are commercially available. Furthermore, the cellular telephone should be competent to initiate and receive data calls or internet transmissions.

Alternatively, the wireless device 14 may be a personal digital assistant (PDA) or notebook computer having cellular telephone functionality and photographic capabilities.

In the example of FIG. 1, the pedestrian 12 desires to store information regarding a point-of-interest, in this case a drugstore 26, to which he may wish to return in the future starting from a different location. He intends to register and store the location of the drugstore 26 with the map server 16. Once having done so, the map server 16 can evaluate the location of the drugstore 26 relative to any subsequent location of the pedestrian 12. The map server 16 may then provide navigation information to the pedestrian 12 that enables him to proceed from the subsequent location to the drugstore 26. To that end the pedestrian 12 aims the camera 22 toward a street sign 28, and acquires an image 30 thereof. The wireless device 14 subsequently transmits the image 30 to the map server 16. The pedestrian 12 may not immediately require the navigation information. Thus, while near real-time acknowledgement of the transaction by the map server 16 is desirable, this is not essential. Indeed, it is an advantage of some aspects of the invention that the map server 16 may process the image 30 off-line, and apply computationally intensive image processing techniques known in the art in order to increase the likelihood of interpreting textual information or other indicia on the street sign 28. Additionally or alternatively, the map server 16 may reference an image database to identify the location of the street sign 28. Further alternatively, the map server 16 may reference other databases, which may contain information relating to the location of the street sign 28.

In any case, the map server 16 interprets the image 30, and eventually locates the nearest point-of-interest of the selected type, i.e., the street sign 28, or several such points of interest in proximity to the pedestrian's location. In the latter case, the pedestrian 12 may select one of the points of interest using an interface offered by the wireless device 14. Some wireless networks may have facilities for approximating the location of a wireless device. For example, it may be known in what city or telephone area code the pedestrian 12 is located simply by identifying the location of a receiving element 32 in the network 18 that was contacted by the wireless device 14. Such information can be exploited by the map server 16 and may enable the exclusion of many candidate points of interest. Once its processing has been completed, the map server 16 stores the location of the point-of-interest, i.e., the street sign 28, and hence the drugstore 26.

Map Server.

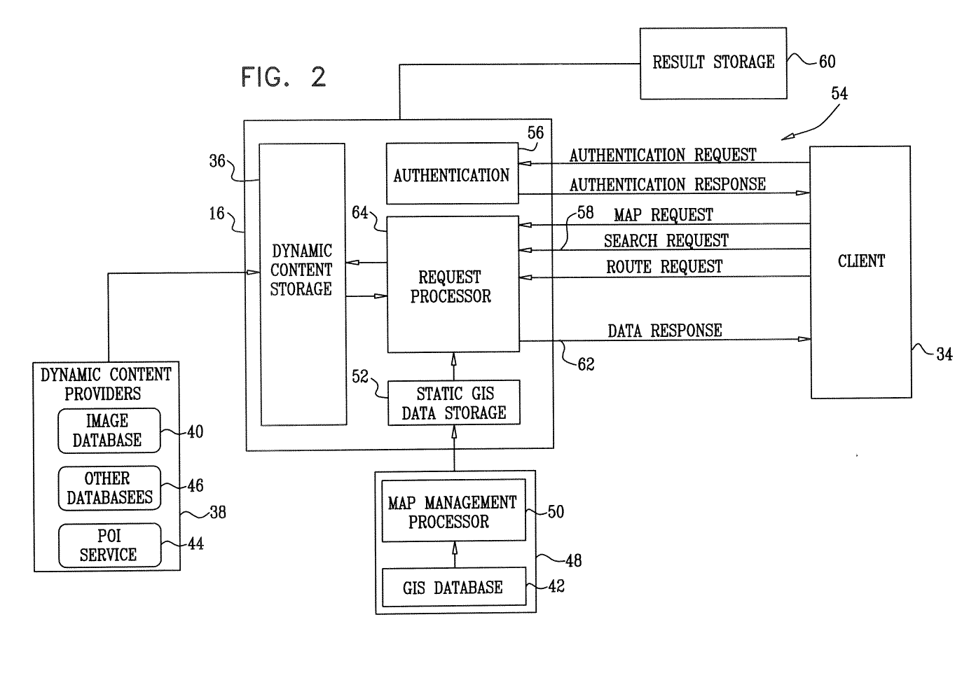

Reference is now made to FIG. 2, which is a simplified functional block diagram of the map server 16 (FIG. 1) constructed and operative in accordance with a disclosed embodiment of the invention. A client-server type of arrangement is provided, wherein the map server 16 communicates with a client 34. In FIG. 1, the wireless device 14 operated by the pedestrian 12 would execute the client 34. The map server 16 typically comprises a general-purpose computer, or a group of computers, with suitable software for carrying out the functions described in functional blocks hereinbelow. This software may be provided to the server in electronic form, over a network, for example, or it may alternatively be provided on tangible media, such as CD-ROM. The functional blocks shown in FIG. 2 are not necessarily physical entities, but are not necessarily separate physical entities, but rather represent different computing tasks or data objects stored in a memory that are accessible to a computer processor.

The map server 16 comprises a dynamic content storage subsystem 36, which receives dynamic content from dynamic content providers 38. Databases offered by the content providers 38 include an image database 40, a geographic database 42, enabling linking of information (attributes) to location data, to addresses, buildings to parcels, or streets, and a point-of-interest service 44 (POI). Other databases 46 may also be employed Additionally or alternatively by the map server 16.

A suitable database for the image database 40 is the Cities and Buildings Database, which is a collection of digitized images of buildings and cities drawn from across time and throughout the world, available from the University of Washington, Seattle, Wash. 98195.

Commercial POI services are suitable for the point-of-interest service 44, for example, the programmable MapPoint® Web Service is a programmable web service available from the Microsoft Corporation. In addition to providing POI data, this service can be used as an accessory to the other facilities of the map server 16 described herein to integrate location-based services, such as maps, driving directions and proximity searches into software applications and business processes.

A static geographical information (GIS) resource 48 supplies GIS data, such as map data, which are generally not dynamic. In the resource 48 the GIS data is provided to a map management processor 50 from a geographic information service database 42, maintained by a GIS data provider, such as Navigation Technologies Inc. (Chicago, Ill.), Tele Atlas North America (Menlo Park, Calif.), or NetGeo, produced by the Cooperative Association for Internet Data Analysis, whose address is CAIDA, UCSD/SDSC, 9500 Gilman Dr., Mail Stop 0505, La Jolla, Calif. 92093-0505. The GIS data are typically supplied in a relational database format to the map management processor 50, which converts the data to a binary format used by the map server 16, and stores the converted data in a binary data storage subsystem 52. The subsystems 52, 36 typically comprise high-capacity hard disk drives for storing static and dynamic data, respectively.

The map management processor 50 is typically operative, inter alia, to receive GIS data in various formats from different GIS data providers and to process the data into a uniform format for storage by the subsystem 52. Normally, the GIS data stored in the geographic information service database 42 are highly detailed, and the map management processor 50 is operative to generalize this data to reduce transmission bandwidth requirements.

Client devices, such as the cellular telephones, PDA's and other communicators use the client 34 to communicate with map server 16 and provide information to users. The client 34 typically comprises an applet written in the Java™ language, but may alternatively comprise other suitable client programs, such as ActiveX™ or C#™, and may run on substantially any stationary or portable computer or on any suitable communicator. Typically, when a client device connects to the map server 16 for the first time, the applet (or other client program) is downloaded to the client device and starts to run. The client program may be stored in the memory of the client device, so that the next time the client device connects to the server, it is not necessary to download the program again.

Typically, upon initiation of operation, the client 34 initiates an authentication sequence 54 with an authentication module 56 of the map server 16. Following authentication, the client 34 may submit requests to the map server 16. In the example of FIG. 1, the request is a search request 58 whose goal is to identify the location of the image 30, which will have been transmitted to the map server 16. Other request types are possible, as will be apparent to those skilled in the art of mobile navigation. The details of the search results are stored on a result storage unit 60, which may be integral with the map server 16, or may be remotely situated. A server response 62 typically is an acknowledgement of the search request 58, the execution of the server response 62 being performed off-line. Alternatively, the server response 62 may include an indication whether the search request 58 was successfully executed, and may further offer other possibilities from which to select.

The client requests and server responses are typically transmitted over a wireless network, such as a cellular network, with which the client device communicates, as shown in FIG. 1. Alternatively or additionally, the client device may communicate with the server through any communications network, such as the Internet. The requests and responses are typically conveyed using communication protocols known in the art, such as TCP/IP and HTTP.

A request processor 64 handles client requests such as the search request 58. For this purpose, the request processor 64 accesses GIS data from binary data storage subsystem 52, as well as dynamic information from the dynamic content storage subsystem 36. Generally, the request processor 64 sends the server response 62 to the client 34 in near real time, typically within four seconds of receiving the request, and preferably within two seconds or even one second of the request.

Further details of data structures, computer programs (server and client) and protocols used by the map server 16 and the client 34 are disclosed in the above-noted U.S. Pat. No. 7,089,110.

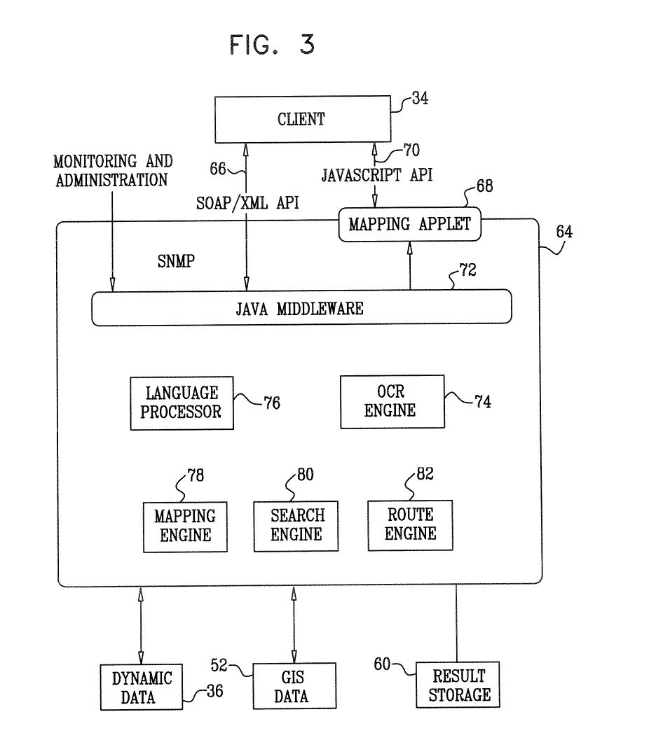

Reference is now made to FIG. 3, which is a more detailed block diagram of the request processor 64 (FIG. 2) that is constructed and operative in accordance with a disclosed embodiment of the invention. Communications with the client 34, including image transmission, are conducted under conventional protocols, e.g., SOAP, MMS, as shown by a link 66, using a suitable API. An alternative communication link is mediated by a JavaScript API and a mapping applet 68, indicated by a link 70. Routine monitoring and administrative functions with an administrative module or server (not shown) are conducted using conventional protocols, e.g., SNMP. In the scenario of FIG. 1, there would be two communications from the wireless device 14 to the request processor 64, a search request, which may be encoded, and the image 30. These may occur in any order, or simultaneously. Additionally or alternatively, and when the image does not include textual information, the image can be referenced against dynamic data obtained from other databases and stored in the subsystem 36 using known image processing and search techniques. Image search services are available, for example, from Google Inc., 1600 Amphitheatre Parkway, Mountain View, Calif. 94043.

Once received by the request processor 64, conventional JAVA middleware 72 processes the data. In the case of transmitted images, textual information that may be present is first interpreted in an OCR engine 74. OCR engines are well known in the art. The OCR engine 74 would determine that textual information is present and would covert it to text, the output of the OCR engine 74, which can be further interpreted and reformatted by a natural language processor 76, which offers multilingual support, and may employ known artificial intelligence techniques to interpret the text. The output of the language processor 76 is the equivalent of typed data that would be input using the conventional text interface of the wireless device 14. The output of the language processor 76 is stored in the result storage unit 60, and may subsequently be recalled for use in many combinations by a mapping engine 78, a search engine 80, and a route engine 82, all of which are known from the above-noted U.S. Pat. No. 7,089,110.

Use Cases.

Referring again to FIG. 1, while the above description contemplates the pedestrian 12 operating the camera 22 manually to acquire the image 30, several other modes of operation are available, additionally or alternatively. The other modes employ an application 84 that executes in a program memory 86 of the wireless device 14 in order to exploit and automatically control its various capabilities. Although the application 84 is shown for conceptual clarity as a separate functional block, the block is not necessarily a separate physical entity, but rather represents a computing task.

In one alternative, the application uses the photographic capabilities of the wireless device 14. The application 84 typically offers a simple user interface, not requiring interaction with external software. By selecting the input field of the application's user interface, instead of using the conventional text input of the wireless device 14, the pedestrian 12 activates the camera 22 and visual information, such as the image 30, is acquired. In this mode of operation, visual inputs may be stored in the wireless device 14 for subsequent operator-assisted review via the user interface, and elective submission to the map server 16. However, this mode of operation may exhaust the limited memory resources of the wireless device 14.

In another alternative, the pedestrian 12 simply stores images in a user “photo gallery”, which is a conventional feature of the wireless device 14. The application 84, typically in an operator-assisted mode, submits flagged images from the photo gallery for submission to the map server 16.

In yet another alternative, visual inputs can be transmitted, e.g., via MMS, to the wireless device 14 from a remote device 15. For example, a remotely acquired image may be substitute for verbal or textual information. Thus, instead of sending directions to a destination verbally or in a text message from the remote device 15 to the wireless device 14, a remotely acquired image of the destination can be transmitted instead, relayed from the wireless device 14 to the map server 16. The map server 16 processes the remotely acquired image, determines its corresponding physical location, and then provides mapping and routing instructions to the pedestrian 12 as taught in the above-noted U.S. Pat. No. 7,089,110. In this mode of operation, any assistance normally provided by the network 18 to locate the wireless device 14 must generally be disabled, as it would be misleading.

The image 30 need not be an image of a landmark, a sign such as the street sign 28, or building structure. It could be, for example, an image of a business card or other text having address information. Indeed, even a handwritten address could be imaged and processed. Any construct that has a geographical significance is a suitable subject for imaging by the camera 22, and submission to the map server 16 for location determination, storage of the location information, and subsequent mapping and navigation assistance to the user by a dynamic navigation system.

### Embodiment 2

Irrespective of whether a visual input to the wireless device is stored within an application, or as MMS-compliant data, address recognition is still required. In Embodiment 1, this process was conducted in the map server 16 (FIG. 1). In this embodiment, OCR and language post-processing are performed on the client device.

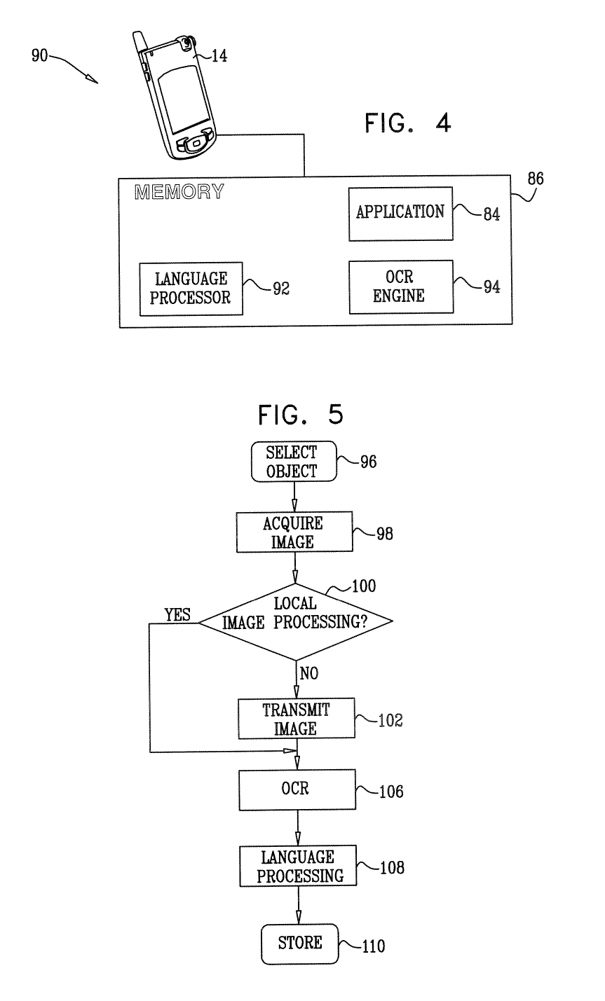

Reference is now made to FIG. 4, which is a pictorial diagram of a wireless device 90 that is constructed and operative for generating visual input for navigation in accordance with a disclosed embodiment of the invention. The wireless device 90 is similar to the wireless device 14 (FIG. 1), but has enhanced capabilities. An OCR engine 92 and optionally a language processor 94 now provide the functionality of the OCR engine 74 and language processor 76 (FIG. 3), respectively, enabling address recognition of a visual image to be performed by the wireless device 90, in which case the OCR engine 74 and language processor 76 in the map server 16 (FIG. 2) may be disabled or omitted. An advantage of this embodiment is that existing dynamic navigation systems that expect text input can be used without modification.

Operation

Mode 1.

Reference is now made to FIG. 5, which is a flow chart of a method of dynamic navigation in accordance with a disclosed embodiment of the invention. The process steps are shown in a particular linear sequence in FIG. 5 for clarity of presentation. However, it will be evident that many of them can be performed in parallel, asynchronously, or in different orders.

At initial step 96 a user having a mobile information device selects an object of interest whose location he desires to be determined for some future navigational purpose. For example, the object can be any of the objects mentioned above, or many others not previously mentioned. It is only necessary that the there be some geographical relevance.

Next, at step 98, using the capabilities of the mobile device an image of the object of interest is captured.

Control now proceeds to decision step 100, where it is determined if the mobile device has image interpretation capabilities, e.g., an OCR engine. If the determination at decision step 100 is affirmative, then control proceeds to decision step 104, which is described below.

If the determination at decision step 100 is negative, then control proceeds to step 102. The image acquired in step 98 is transmitted from the mobile information device to a remote server. Normally this is a wireless transmission. However, a wired network can also be employed if convenient. As noted above, intermediate mobile information devices can be employed to relay the image to the remote server.

After performance of step 102, or in the event that the determination at decision step 100 is affirmative, Control proceeds to step 106. The OCR Engine converts the textual information in the image to another textual format, e.g., ASCII, which is suitable for post-processing and interpretation.

Next, at step 108 a language processor interprets the text and reformats it, such that the output of the language processor is an acceptable input to a conventional dynamic navigation system.

After performance of step 108, control proceeds to final step 110. The textual information is stored for subsequent recall by a dynamic navigation system. Storage can occur in the mobile device or in a remote server. When the stored information is recalled, the dynamic navigation system conventionally provides navigation information to the location shown on the image to the mobile device relative to its current location, which will usually have changed subsequent to acquisition of the image.

Mode 2.

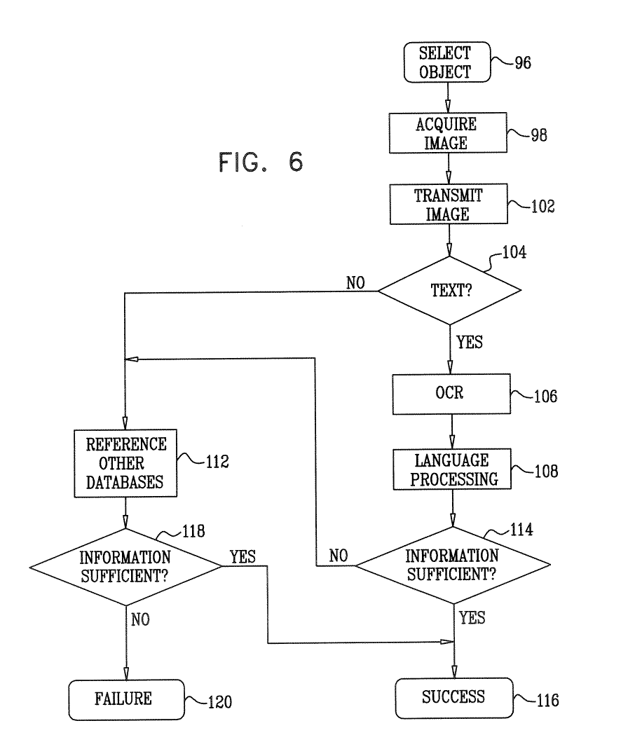

Reference is now made to FIG. 6, which is a flow chart of a method of dynamic navigation in accordance with an alternate embodiment of the invention. In this embodiment, image textual evaluation of an image may be augmented by reference to other databases. Steps 96, 98, 102 are performed as described above.

The method then continues at decision step 104, where it is determined if textual information is present on the image. If the determination at decision step 104 is negative, then control proceeds to step 112, which is described below.

If the determination at decision step 104 is affirmative, then steps 106, 108 are performed as previously described, either by the mobile device or by a remote server.

Control now proceeds to decision step 114, where it is determined if the textual information recovered in steps 106, 108 meets the criteria for an address or location according to the specifications of the navigation system being used. If the determination at decision step 114 is affirmative, then control proceeds to final step 116. The information is stored for subsequent recall by the navigation system, which conventionally identifies position coordinates of the identified location, and then transmits mapping or routing information to the mobile device relative to its current location or another user-specified location.

If the determination at decision step 114 or decision step 104 is negative, then control proceeds to step 112. The transmitted image is referenced against other image databases, e.g., one or more of the image database 40, point-of-interest service 44, and the other databases 46 (FIG. 2).

Control now proceeds to decision step 118, where it is determined if the processing in step 112 yielded sufficient information to meet the criteria for an address or location according to the specifications of the navigation system being used. If the determination at decision step 118 is affirmative, then control proceeds to final step 116. The information is stored and the procedure terminates successfully.

If the determination at decision step 118 is negative, then control proceeds to final step 120. The procedure terminates in failure.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for navigation, comprising the steps of:
capturing an image using a mobile device;
transferring data relating to said image to a remote facility;
processing said image to identify a location associated with said image; and
communicating information from said remote facility to said mobile device describing navigation to said location.

2. The method according to claim 1, wherein processing said image comprises wirelessly transmitting said image from said mobile device to a remote server.

3. The method according to claim 1, wherein processing said image comprises performing optical character recognition.

4. The method according to claim 3, wherein said step of processing said image is performed in said mobile device.

5. The method according to claim 3, wherein said step of processing said image is performed in a remote server.

6. The method according to claim 1, wherein processing said image comprises referencing an image database.

7. The method according to claim 1, wherein said mobile device is a cellular telephone having a camera incorporated therein.

8. The method according to claim 1, wherein said step of capturing an image comprises the steps of:
acquiring said image with another mobile device; and
transmitting said image from said another mobile device to said mobile device.

9. A computer program product for supporting mobile navigation, including a tangible computer-readable medium in which computer program instructions are stored, which instructions, when read by a computer, cause the computer to command a mobile device having a photographic capability to:
capture an image;
transmit said image to a remote dynamic navigation facility;
instruct said facility to identify a location in said image; and
instruct said facility to transmit to said mobile device information describing navigation to said location.

10. The computer program product according to claim 9, wherein said instructions cause the computer to command said mobile device to instruct said facility to perform optical character recognition on said image and to identify said location using textual data obtained therefrom.

11. The computer program product according to claim 9, wherein said instructions cause the computer to command said mobile device to instruct said facility to process said image by referencing an image database and to identify said location using information obtained from said image database.

12. The computer program product according to claim 9, wherein said mobile device is a cellular telephone having a camera incorporated therein.

13. A mobile information device for supporting mobile navigation, comprising:
a transmitter;
a camera;
a memory having stored therein program instructions; and
a processor operative for executing said instructions, wherein said instructions cause said processor to command said camera to capture an image, said instructions further causing said processor to command said transmitter to transmit said image to a remote dynamic navigation facility, instruct said facility to identify a location in said image, and instruct said facility to transmit to said mobile information device information describing navigation to said location.

14. The mobile information device according to claim 13, wherein said instructions cause said processor to instruct said facility to process said image by performing optical character recognition thereon and to identify said location using textual data obtained therefrom.

15. The mobile information device according to claim 13, wherein said instructions cause said processor to instruct said facility to process said image by referencing an image database and to identify said location using information obtained therefrom.

16. The mobile information device according to claim 13, wherein said mobile information device is a cellular telephone.

17. A method for navigation, comprising the steps of:
capturing an image using a mobile device;
transferring said image to a remote facility;
processing said image to identify textual information associated with said image;
processing said textual information in a navigation system to identify a location associated with said image; and
communicating information from said navigation system to said mobile device describing navigation to said location.

18. The method according to claim 17, wherein processing said image comprises wirelessly transmitting said image from said mobile device to said remote facility.

19. The method according to claim 17, wherein said step of processing said image is performed in said mobile device.

20. The method according to claim 17, wherein said step of processing said image is performed in said remote facility.
